(19) United States
(12) Patent Application Publication
(10) Pub. No.: US 2016/0274312 A1
(43) Pub. Date: Sep. 22, 2016

(54) Attachable Disposable Fiber Optic Cleaning Pad

(71) Applicant: AFL TELECOMMUNICATIONS LLC, Duncan, SC (US)

(72) Inventors: Sean Patrick Adam, Wrentham, MA (US); D. Dane Krampitz, Groton, MA (US); Ellis C N G Delglyn, Tomar (PT); Lee H. Kellet, Hopkinton, MA (US)

(21) Appl. No.: 15/028,987

(22) PCT Filed: Oct. 16, 2014
(86) PCT No.: PCT/US14/60909

§ 371 Date: Apr. 13, 2016

Related U.S. Application Data
(60) Provisional application No. 61/891,718, filed on Oct. 16, 2013.

(51) Int. Cl. G02B 6/38; B08B 1/00

(52) U.S. Cl. CPC G02B 6/3866; B08B 1/006

(57) ABSTRACT

One or more embodiments of the disclosure relates to a fiber optic cleaning pad for cleaning the end-face of an optical fiber. The cleaning pad includes a base for support and a fiber optic cleaning area for cleaning the end-face. The cleaning pad includes a mounting attachment to attach the cleaning pad to an object, such as a person or clothing.

### CROSS-REFERENCE TO RELATED APPLICATIONS

This application is based upon and claims the benefit of priority from U.S. Provisional Application No. 61/891,718, filed Oct. 16, 2013, in the United States Patent and Trademark Office, the disclosure of which is incorporated herein in its entirety by reference.

### FIELD OF THE INVENTION

The invention is related to an apparatus for holding a cleaning pad for use with an optical fiber.

### BACKGROUND

In the related art of optical fiber applications, the presence of dirt or other contaminants on an end-face of an optical fiber can affect performance. While optical fiber can be a powerful medium for transfer of data and sensing applications, contaminants on an optical fiber end-face can reduce and even completely inhibit the transfer of information on the optical fiber. As a whole, the fiber optic industry spends millions of dollars a year on cleaning and inspection tools.

In many instances, field technicians may not actually clean the fiber end-faces correctly with the proper tools. This is backed by cleaning revenue in those regions where large firms have simply given up trying to make their field technicians clean and deal with the fallout as best they can.

Often, field technicians merely make attempts at cleaning by wiping the end-face on the field technician's clothing.

### SUMMARY

Although cleaning tools exist for end-faces of optical fibers, these tools require the field technician to use additional effort. Applicant recognizes that if the field technician does not wish to expend the extra effort, the purchased cleaning equipment merely sits unused in offices and trucks.

Instead of merely providing cleaning tools, Applicant recognizes the technician may not expend the effort to alter or adjust the normal workflow.

One or more embodiments of the disclosure relates to a disposable fiber optic cleaning pad. This pad would easily attach to a field technician's shirt or sleeve. The cleaning pad would allow the field technician to place it wherever it is most convenient and consistent with their practice of cleaning it on their shirt. Accordingly, the cleaning pad provides a means for cleaning which fits the field technician's work style and work flow. Use of the cleaning pad does not mean forcibly trying to change the field technician's work flow with additional steps that they may not embrace.

In one embodiment, the disposable pad may be made up of a base, a mounting attachment, and a fiber optic cleaning area. The base material provides the overall structure of the cleaning pad. The mounting attachment is a way by which the cleaning pad can be attached to an object, such as clothing, hard surfaces, or equipment. The fiber optic cleaning area may be a material for cleaning of the end-face of the optical fiber.

In one embodiment, the base may be stiff. Alternatively, the base may have flexibility in order to conform to an object to which the cleaning pad attaches.

In different embodiments, the mounting attachment provides at least one way to attach the cleaning pad to an object. The mounting attachment may include, but is not limited to, at least one of hook-and-loop fasteners, clips, adhesives, water soluble glue, adhesive tape, straps, magnets, and static cling. The mounting attachment allows the cleaning pad to be attached to a person or their clothing (e.g. chest or arm), to their equipment (e.g. OTDR), or to their current environment (e.g. rack).

In some embodiments, the fiber optic cleaning area may include a dry-cleaning, weaved polyester cloth. In some embodiments, the fiber optic cleaning area may include a wet wipe cloth. Further, some embodiments may have a combination of different types of cloth, dry and wet, as the fiber optic cleaning area.

Further, in some embodiments, the fiber optic cleaning area may have a protection means to prevent general contamination. In one embodiment, the protection means may be at least one protective blind. The end face would slip through the blinds to come into contact with the fiber optic cleaning area. Additionally, the blinds could serve as a coarse cleaner by knocking off debris from the optical fiber.

In one embodiment, the fiber optic cleaning area may be protected by a protective cover. The protective cover would cover the fiber optic cleaning area when the cleaning pad is not in use and be removed when the cleaning pad is used.

In some embodiments, a time-of-exposure discolorent may be applied to the cleaning pad. This would provide visual guidance to the field technician as to how long the pad has been in use and when it should be replaced. Also, the fiber optic cleaning area may include a discolorent to indicate use.

According to an embodiment, the fiber optic cleaning area is disposed on a first side of the base and the mounting attachment is disposed on a second side of the base.

Alternatively, the mounting attachment and the fiber optic cleaning area may both be disposed on a same side of the base.

Some embodiments provide that the fiber optic cleaning area can be a removable component attached to the base. The base may serve as a holder and the fiber optic cleaning area may be a replaceable cleaning insert.

### BRIEF DESCRIPTION OF THE DRAWING

FIG. 1 shows an exemplary embodiment of a fiber optic cleaning pad.

FIG. 2 shows a second exemplary embodiment of the fiber optic cleaning pad with a protective screen.

FIG. 3 shows another exemplary embodiment of the fiber optic cleaning pad with a protective cover.

FIG. 4 shows another exemplary embodiment of the fiber optic cleaning pad with an area having a protective screen and an area having a protective cover.

FIG. 5 shows an opposed side of an exemplary embodiment and a mounting attachment.

### DETAILED DESCRIPTION

Embodiments will be described below in more detail with reference to the accompanying drawings. The following detailed descriptions are provided to assist the reader in gaining a comprehensive understanding of the methods, apparatuses, and/or systems described herein, and equivalent modifications. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

In applications of fiber optics, it is important that the end-face of an optical fiber be clean of debris or contaminants. Embodiments of an optical fiber cleaning pad provide a way for the field technician to clean an end-face while presenting minimal diversion from a work flow.

According to an embodiment of the optical fiber cleaning pad, the cleaning pad may be comprised of two pieces, a base 11 and a fiber optic cleaning area 12.

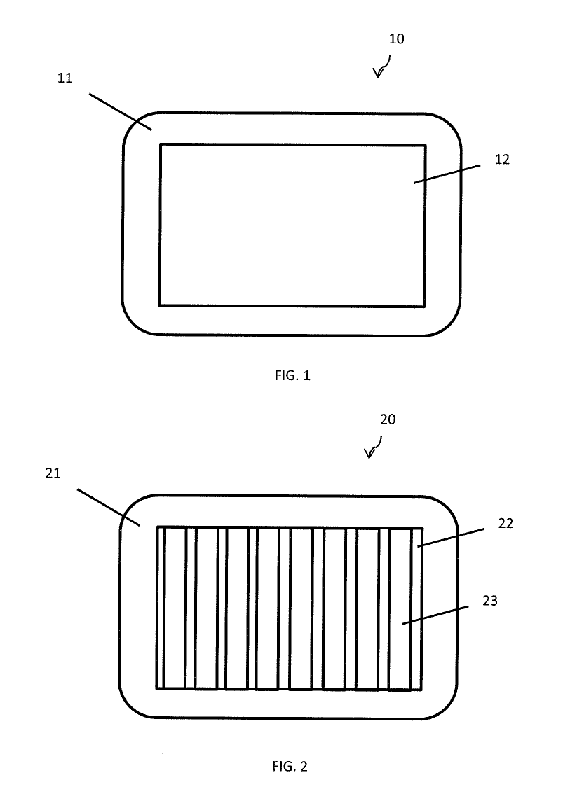

FIG. 1 shows an exemplary embodiment of the present disclosure. The cleaning pad 10 includes a base 11 and a fiber optic cleaning area 12. The base 11 provides an overall structure for the cleaning pad. The fiber optic cleaning area 12 is on at least one side of the base 11.

The base may be stiff to provide rigidity to the cleaning pad. Alternatively, the base may have flexibility in order to conform to an object to which the cleaning pad attaches. While the exemplary base 11 is rectangular, the base 11 may be of a variety of shapes including a circle or polygon.

The fiber optic cleaning area 12 may be comprised of at least one suitable cleaning material. For example, the fiber optic cleaning area may include a dry-cleaning, weaved polyester cloth. However, in other embodiments, the fiber optic cleaning area may use other materials such as a wet wipe cloth. Further, some embodiments may have a combination of different types of cloth, dry and wet, as the fiber optic cleaning area. While the exemplary fiber optic cleaning area 12 is rectangular, the fiber optic cleaning area 12 may be of a variety of shapes including a circle or polygon. In an alternative embodiment, the fiber optic cleaning area may be on both sides of the base.

The base 11 may have a mounting attachment, including, but not limited to, at least one of hook-and-loop fasteners, clips, adhesives, water soluble glue, adhesive tape, straps, magnets, and static cling. The mounting attachment may be on an opposed side of the base from the fiber optic cleaning area. The mounting attachment may cover the entire opposite side of the base or it may cover only a portion. Alternatively, the mounting attachment may be on the same side of a base 11 as a fiber optic cleaning area 12. In a non-limiting example, the mounting attachment may be on the base 11 around the periphery of the fiber optic cleaning area 12. This may allow for protection of the fiber optic cleaning area 12 until a field technician removes and reveals the fiber optic cleaning area.

Additionally, a time-of-exposure discolorent may be applied to the base of the cleaning pad. This would provide visual guidance to the field technician as to how long the pad has been in use and when it should be replaced.

Also, the fiber optic cleaning area may have a discolorent to discolor itself after use in order to expose sections of the fiber optic cleaning area which have been used and sections of the fiber optic cleaning area which have not been used. One exemplary discolorent may be a pressure discolorent for indicating use.

FIG. 2 shows an exemplary embodiment of a cleaning pad 20, having a base 21 and a fiber optic cleaning area 22, where the fiber optic cleaning area is covered by protective blinds 23. The protective blinds 23 may be arranged across the fiber optic cleaning area 22. The protective blinds may be one blind or a plurality of blinds. Also, arrangement of the protective blinds may be in a set of parallel blinds or they may be arranged in an alternative arrangement as necessary. Non-limiting examples of alternative arrangements may include an x-shape crisscrossing, horizontally oriented, vertically oriented, or zig-zag configurations. The protective blinds may have sufficient flexibility to allow the end-face of an optical fiber to push aside the protective blind to access the fiber optic cleaning area for cleaning. The protective blinds provide protection over the fiber optic cleaning area to prevent contamination of the fiber optic cleaning area during normal use.

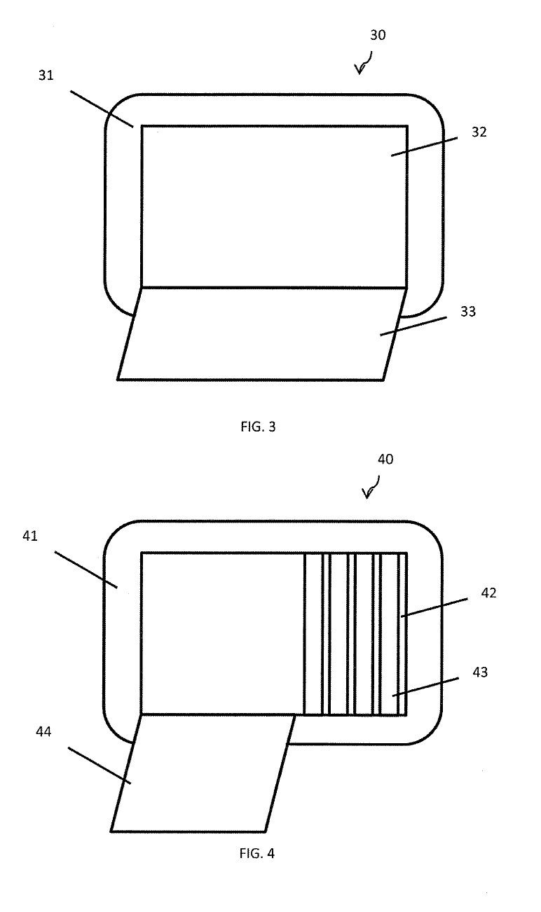

FIG. 3 shows an embodiment of a cleaning pad 30, having a base 31 and a fiber optic cleaning area 32, where the fiber optic cleaning area 32 is covered by a protective cover 33. The protective cover 33 may be attached to the base 31, fiber optic cleaning area 32, or both in order to provide protection over the fiber optic cleaning area to prevent contamination of the fiber optic cleaning area during normal use. The protective cover 33 is moveable or rotatable relative to the fiber optic cleaning area 32 in order to unmask and mask the fiber optic cleaning area 32 as necessary.

FIG. 4 shows an embodiment of a cleaning pad 40, having a base 41 and a fiber optic cleaning area 42, where the fiber optic cleaning area 42 is covered by protective blinds 43 and a protective cover 44. The protective blinds 43 may cover a first portion of the fiber optic cleaning area 42 and the protective cover 44 may cover a second portion of the fiber optic cleaning area 42. Additionally, there may be additional divisions of protective blinds and protective cover areas on a fiber optic cleaning area 42.

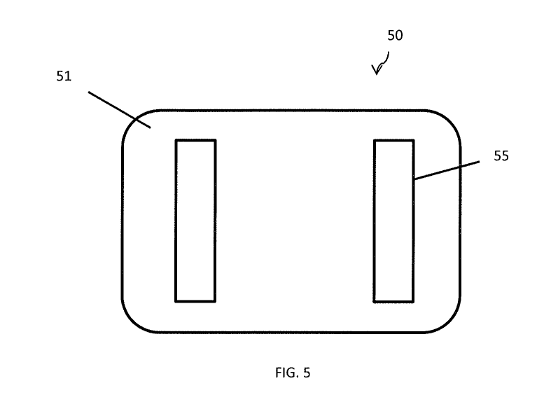

FIG. 5 shows an embodiment of a cleaning pad 50 having mounting straps 55 as a mounting attachment on an opposed side of the base 51 from a fiber optic cleaning area. The mounting attachment for a cleaning pad, including, but not limited to, at least one of hook-and-loop fasteners, clips, adhesives, adhesive tape, straps, magnets, and static cling, may cover the entire opposite side of the base or it may cover only a portion. FIG. 5 shows one embodiment using two mounting straps 55 as a mounting attachment such that corresponding sizing of the cleaning pad 50 may allow for a user to wear the cleaning pad as a wristlet or arm band.

According to some embodiments, the fiber optic cleaning area can be a removable component attached to the base. The base may include a holder for the fiber optic cleaning area and the fiber optic cleaning area may be a replaceable cleaning insert. In these embodiments, the fiber optic cleaning area replaceable cleaning insert is held by the holder for attachment to the base. The fiber optic cleaning area as embodied in a replaceable cleaning insert may be attached to the base by, but not limited to, at least one of hook-and-loop fasteners, clips, adhesives, adhesive tape, straps, magnets, and static cling. In this way, the base may remain attached to the field technician while a replaceable cleaning insert can be replaced after use.

Alternatively, the base may further attach to a holder and the holder then holds a replaceable cleaning insert. Accordingly, the base may either attach to a holder or directly to a replaceable cleaning insert.

Unlike existing solutions, the cleaning pads of the embodiments would allow a cleaning solution which matches the existing work-flow of the field technician. The field technician can still wipe off the end face of the optical fiber on their chest or arm as they previous have. However, with the use of the fiber optic cleaning pad, the field technician will be wiping the end-face on an actual dry-cleaning solution instead of their shirt. The disposable cleaning pad now can enable employers to stress the importance of cleaning while not disrupting the overall workflow of the field technicians.

Even in regions where cleaning is embraced, the cleaning pad can provide a potential efficiency improvement over other existing wet and dry cleaning solutions due to fact that it easily attaches to the person, requires only one-hand execution verse picking up other tools (e.g. cleaning pens, cleaning wipes), is inexpensive, and is disposable.

Also, depending on the materials used, such as cardboard for the base, the cleaning pad can be environmentally friendly without the use of plastic housings.

While this specification contains many features, the features should not be construed as limitations on the scope of the disclosure or of the appended claims. Certain features described in the context of separate embodiments can also be implemented in combination. Conversely, various features described in the context of a single exemplary embodiment can also be implemented in multiple exemplary embodiments separately or in any suitable sub-combination.

The various components of the fiber optic cleaning pad may be made from a variety of materials, not limited to cardboard, metals, composites, or plastics. It is noted that various combinations of components of similar or differing materials may be used.

1. A fiber optic cleaning pad, the cleaning pad comprising:
a base having a mounting attachment, and
a fiber optic cleaning area disposed on the base.

2. The cleaning pad according to claim 1, wherein the mounting attachment comprises at least one of hook or loop fasteners, clips, adhesive, water soluble glue, adhesive tape, a mounting strap, magnetic, and static cling.

3. The cleaning pad according to claim 1, wherein the fiber optic cleaning area comprises a dry-cleaning, weaved polyester cloth.

4. The cleaning pad according to claim 1, wherein the fiber optic cleaning area is disposed on a first side of the base and the mounting attachment is disposed on a second side of the base.

5. The cleaning pad according to claim 1, the cleaning pad further comprising:
at least one protective blind covering a portion of the fiber optic cleaning area.

6. The cleaning pad according to claim 1, the cleaning pad further comprising:
at least one protective cover covering a portion of the fiber optic cleaning area.

7. The cleaning pad according to claim 1, wherein the base comprises a time-of-exposure discolorent.

8. The cleaning pad according to claim 1, wherein the fiber optic cleaning area comprises a discolorent to indicate use.

9. The cleaning pad according to claim 1, further comprising:
at least one protective blind covering a first portion of the fiber optic cleaning area at least one protective cover covering a second portion of the fiber optic cleaning area.

10. The cleaning pad according to claim 1, wherein the mounting attachment and the fiber optic cleaning area are both disposed on a same side of the base.

11. The cleaning pad according to claim 1, wherein the fiber optic cleaning area is a removable component attached to the base.

12. The cleaning pad according to claim 1, wherein said mounting attachment is configured to mount on a user.
